(19) United States
(12) Patent Application Publication
(10) Pub. No.: US 2007/0114130 A1
(43) Pub. Date: May 24, 2007

(54) Gas sensors and methods of manufacture

(76) Inventors: Earl W. Lankheet, Grand Blanc, MI (US); Paul H. Ruterbusch, Flushing, MI (US); David B. Quinn, Grand Blanc, MI (US); Fred Bolf JR., Chesaning, MI (US)

Correspondence Address: Paul L. Marshall;Delphi Technologies, Inc., M/C 480-410-202, P.O. Box 5052, Troy, MI, 48007, US

(21) Appl. No.: 11/282,258

(22) Filed: Nov. 18, 2005

(51) Int. Cl. G01N 27/26

(52) U.S. Cl. 204/424

(57) ABSTRACT

Disclosed herein is a gas sensor that comprises a sensor cell, a sensing side support layer, and a reference side support layer. The sensor cell comprises an electrolyte layer, a sensing electrode and a reference electrode, wherein the sensing electrode is disposed on a sensing side of the electrolyte layer, and the reference electrode is disposed on a reference side of the electrolyte layer. The reference side has a reference thickness of about 40% to about 160% of a sensing thickness of the sensing side. Methods for manufacturing gas sensors are also disclosed.

### TECHNICAL FIELD

This disclosure generally relates to planar gas sensors and methods of their manufacture.

### BACKGROUND

Potentiometric gas sensors can be employed in automotive vehicles to monitor the composition of exhaust gases within the exhaust stream. The composition of exhaust gases is of interest as it can provide feedback that allows for the determination of optimum engine operating conditions and exhaust treatment device performance.

Gas sensors can be produced in various configurations, such as, but not limited to, cylindrical and planar designs. In planar designs, the device can be constructed by assembling a plurality of layers into a laminate, which can be co-fired (i.e. sintered) to fuse the layers into a solid sensing element. Although many other processes of assembly can be employed, sintering the laminate can reduce manufacturing and overall part cost. However, sintered designs are subject to manufacturing obstacles, such as warpage during the sintering process. Warpage can occur due to several variables and contributes to costly production scrap-rates, high raw materials costs, difficult parts handling and packaging, and high quality assurance costs.

Innovations in planar gas sensor designs that reduce or eliminate warpage and reduce sensor manufacturing costs are desirable for manufacturers and consumers alike. Disclosed herein are sensor designs and methods of manufacture that can reduce or eliminate sensor warpage.

### BRIEF SUMMARY

Disclosed herein are methods for manufacturing gas sensors and sensors made therefrom. In one embodiment a gas sensor comprises: a sensor cell, comprising an electrolyte layer, a sensing electrode and a reference electrode, wherein the sensing electrode is disposed on a sensing side of the electrolyte layer, and the reference electrode is disposed on a reference side of the electrolyte layer, a sensing side support layer disposed on the sensing side, and a reference side support layer disposed on the reference side. The reference side has a reference thickness of about 40% to about 160% of a sensing thickness of the sensing side.

In a second embodiment a method of making a gas sensor comprises, forming a sensor cell comprising an electrolyte layer, a sensing electrode and a reference electrode, wherein the sensing electrode is disposed on a sensing side of the electrolyte layer, and the reference electrode is disposed on a reference side of the electrolyte layer, disposing a sensing side support layer on the sensing side, and disposing a reference side support layer on the reference side. The reference side has a reference thickness of about 40% to about 160% of a sensing thickness of the sensing side.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is an exploded isometric view of an exemplary basic sensor 100.

FIG. 2 is an exploded isometric view of an exemplary balanced sensor 200.

### DETAILED DESCRIPTION

Disclosed herein are planar gas sensors and methods of manufacture that can reduce or eliminate warpage during sintering. More specifically, designs for planar gas sensors are disclosed which reduce or eliminate warpage by adding and/or removing support layers to attain a more “balanced” design about the electrolyte layer, which can reduce the effects of disproportionate coefficients of shrinkage between layers. In addition, device designs and methods of manufacture are disclosed herein that incorporate a sensor window, which enables an overall reduction in raw material costs of multiple components and also reduces the potential of warpage.

At the outset, for clarity purposes, it is to be apparent that a plurality of planar gas sensor designs are disclosed herein. It is also to be understood that these devices can also be described as using general terms (e.g. “gas sensors”, “sensors”, “devices”). The modifier “about” used in connection with a quantity is inclusive of the stated value and has the meaning dictated by the context (e.g., includes the degree of error associated with measurement of the particular quantity). Furthermore, ranges disclosed herein are inclusive and independently combinable (e.g., ranges of “up to about 25 wt %, with about 5 wt % to about 20 wt % desired”, are inclusive of the endpoints and all intermediate values of the ranges of “about 5 wt % to about 25 wt %,” etc). Furthermore, the terms “first,” “second,” and the like, herein do not denote any order, quantity, or importance, but rather are used to distinguish one element from another. Moreover, the terms “a” and “an” herein do not denote a limitation of quantity, but rather denote the presence of at least one of the referenced item. Also, the terms “front”, “back”, “bottom”, and/or “top” are used herein, unless otherwise noted, merely for convenience of description, and are not limited to any one position or spatial orientation. The suffix “(s)” as used herein is intended to include both the singular and the plural of the term that it modifies, thereby including one or more of that term (e.g., the colorant(s) includes one or more colorants).

Planar gas sensors (e.g., narrow-band sensors, switch-like sensors, potentiometric sensors, and the like) comprise a “sensor cell”, which comprises an ionically conductive electrolyte layer, a porous sensing electrode disposed on a sensing side of the electrolyte layer, and a porous reference electrode disposed on a reference side of the layer. In this configuration, the sensor cell operates in a potentiometric mode, which can generate an electromotive force across the electrolyte layer that can be measured using the sensing electrode and reference electrode. In oxygen sensors for example, oxygen partial pressure differences between a “test gas” in contact with the sensing electrode and a reference gas in contact with the reference electrode develop an electromotive force across the electrolyte.

The operation of the sensing cell can be described by the Nernst equation:

$$E = ( \frac{RT}{4 F} ) ln ( \frac{{P}_{{O}_{2}}^{ref}}{{P}_{{O}_{2}}} )$$

Where: E=electromotive force
R=universal gas constant
F=Faraday constant
T=absolute temperature of the gas
P_{O}_{₂}^{ref}=oxygen partial pressure of the reference gas
P_{O}_{₂}=oxygen partial pressure of the exhaust gas

More specifically, an oxygen sensor employed in an exhaust treatment application can expose the sensing electrode to the exhaust stream and the reference electrode to atmospheric air. As a result, an electromotive force is generated across the electrolyte that can be measured to enable control of the exhaust source and/or to enable monitoring of the exhaust system. If the exhaust source (e.g., an internal combustion engine) is operating rich, a rich exhaust stream (oxygen poor) will be produced. Under these conditions the oxygen partial pressure differential across the cell will be high, producing a high electromotive force. In contrast, if the engine is operating lean, a lean exhaust stream (oxygen rich) will be produced. This will create a low oxygen partial pressure differential, which results in a low electromotive force across the cell. Although the electromotive force can be amplified to allow for easier measurement, the response from the potentiometric cell provides limited fidelity. This is because the electromotive force across the cell changes dramatically from fuel-rich to fuel lean conditions at air to fuel ratios close to ideal stoichiometry. This characteristic behavior warrants the “switch-type” and “narrow-band” namesakes. However “broad-band” gas sensors have also been produced that offer improved fidelity from rich to lean exhaust mixtures.

Gas sensors can be produced in planar designs, wherein a plurality of layers can be assembled to form a laminate or assembly. The layers can generally comprise support layer(s) and an electrolyte layer(s). The electrolyte layer is employed as the electrolyte component of the sensor cell, on which the cell's sensor and reference electrodes can be disposed. The support layers can comprise additional components, such as, but not limited to, heaters, temperature sensors, ground planes, additional cells, gas channels, and the like. The support layers can be assembled onto the sensing side and the reference side of the electrolyte layer to enable the function of the device and provide additional durability to the sensor.

The layers can be assembled in their “green” or “unfired” state, and then fused into a solid sensing element during a sintering process. Although there are benefits to the process of laminating and sintering the assembly (e.g. reduced number of sintering operations, excellent layer adhesion, reduced overall part cost), the process can also yield the detriment of assembly warpage.

Generally, warpage can occur during the sintering process due to differences in the amount of shrinkage between the various layers of the laminate. For example, if two layers are laminated on one another and fired, if the top layer shrinks more than the bottom layer, the top layer will pull on the bottom layer and form a concave shaped part. In some designs that employ similar materials for all layers, warping can be reduced or eliminated by placing strict controls on the material's shrinkage properties to ensure part-to-part and lot-to-lot consistency (e.g., coefficient of shrinkage testing, purity testing, and the like). In designs that employ more than one material for the devices layers, this method of controlling the materials shrinkage properties can be difficult or non-effective if the inherent material shrinkage differences are excessive or the cost of implementation is unwarranted.

In some gas sensor configurations, the materials employed for the support layers can differ from the materials used for the electrolyte layer. Although not bound by theory, in these designs, “balancing” the device's layers can provide a method of reducing warpage. For example, if the sensor employs one electrolyte layer and six support layers, and the materials employed for the electrolyte layer differ from that employed for the support layers, disposing the electrolyte layer closer to the center, or mid-plane, of the laminate can produce a theoretically balanced design (e.g. layering three support layers on the top of an electrolyte layer and three support layers on the bottom of the electrolyte layer). Contrarily, a sensor design comprising one support layer on the top of the electrolyte layer, and five support layers on the bottom of the electrolyte layer, is theoretically less balanced in design and more susceptible to warpage. It is to be understood however, that these examples are utilized to illustrate some of the principles that will be discussed herein. It is also to be apparent that the properties of sensors are not as predictable as described in the examples above for the reason that additional components and elements are supported between the layers of the sensor assembly, which affect the warping characteristics of the device during sintering. For example, a layer of porous material can be applied on the devices sensing electrode to increase the devices resistance to contaminants in the test gas stream. The shrinkage properties of this layer can differ from the electrolyte and support layers, causing warpage at the tip of the sensor.

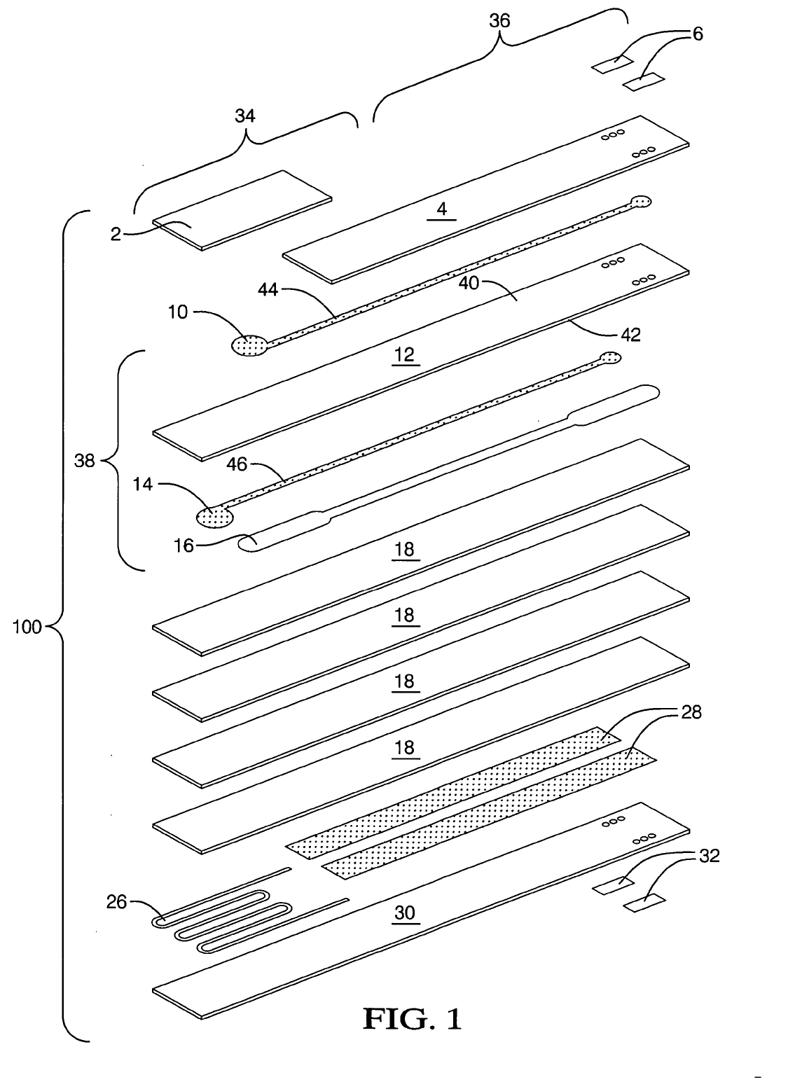

Referring now to FIG. 1, an exploded isometric view of an exemplary basic sensor is illustrated, and generally designated 100. The basic sensor 100 comprises a sensor cell 38, which comprises an electrolyte layer 12, a sensing electrode 10, and a reference electrode 14. The electrolyte layer 12 comprises a top surface 40 and a bottom surface 42. Disposed on the top surface 40 can be a sensing electrode 10 and a sensor lead 44, which are connected in electrical communication. Disposed on the bottom surface 42 can be a reference electrode 14, a reference lead 46 and a gas channel, which are connected in operable communication.

The side of the electrolyte layer 12 that comprises the sensing electrode 10 can be referred to as the sensing side of the sensor, and the side comprising the reference electrode can be referred to as the reference side of the sensor. Furthermore, the end of the basic sensor 100 that comprises the sensing electrode 10 can be referred to as the sensing end 34, and the opposite end of the basic sensor 100 (that comprises the sensor contact 6) can be referred to as the connecting end 36.

Disposed on the sensing side can be an outer support layer 4 that can be layered onto the top surface 40 of the electrolyte layer 12. Sensor contacts 6 can be disposed on the outer support layer's outer surface, and connected in electrical communication with sensor lead 44 and reference lead 46. On the sensing end 34 of the electrolyte layer 12 a porous protective layer 2 can be disposed on the top surface 40, adjacent to the outer support layer 4. The porous protective layer 2 is capable of allowing fluid communication between the sensing electrode 10 and the environment around the sensor.

Disposed on the reference side can be a plurality of insulating layers 18 that are layered onto the bottom surface 42. A heating element 26 and leads 28 can be disposed between the outermost insulating layer 18 and a heater support layer 30, wherein the heating element 26 and leads 28 are connected in electrical communication. Disposed on the outer surface of the heater support layer 30 can be heater contacts 32, which are in electrical communication with leads 28. This can be generically referred to as the heating side of a gas sensor. After assembly, the sensing end 34 can be coated with a coating (not shown) that can protect the sensor from acidic gases within an exhaust stream.

The basic sensor 100 illustrated in FIG. 1 comprises a generally laminar design comprising six support layers (outer support layer 4, four insulating layers 18, and heater support layer 30) and one electrolyte layer 12. The electrolyte layer 12 is disposed as the second layer from the top of the assembly to allow fluid communication between the sensing electrode 10 and a test gas in the environment around the sensor through the porous protective layer 2. In this configuration, basic sensor 100 can be predisposed to warp during sintering due to the laminates poorly balanced design and combination of differing materials. To be more specific, basic sensor 100 can employ yttria-stabilized zirconia for the electrolyte layer 12 and alumina for the support layers. With one support layer (outer support layer 4) on the top surface 40 of the electrolyte layer 12 and five “support layers” (four insulating layers 18 and heater support layer 30) disposed on the bottom surface 42, coupled with the differing materials utilized for the support layers and the electrolyte layer 12, it can be expected basic sensor 100 will warp during sintering. It is also to be noted that the basic sensor 100 employs a porous protective layer 2 on the sensing end 34 of the device. The porous protective layer 2 can comprise a porous alumina “tape” material that can differ in shrinkage from the alumina support layers. Resulting in a tendency for the sensing end 34 of the device to warp during sintering.

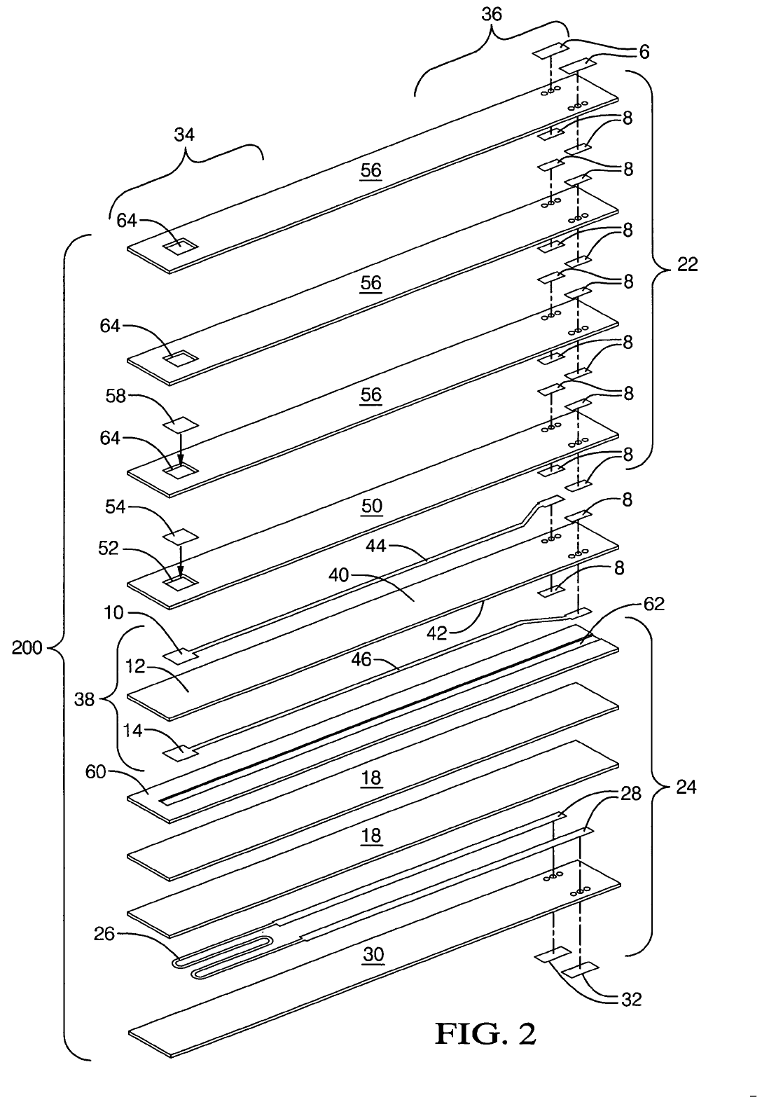

Referring now to FIG. 2, an exploded isometric view of an exemplary balanced sensor 200 is illustrated. The balanced sensor 200 comprises a sensor cell 38 comprising an electrolyte layer 12, a sensing electrode 10 and a reference electrode 14. The electrolyte layer 12 comprises a top surface 40 and a bottom surface 42. The sensing electrode 10, a sensor lead 44, and a conductive pad 8 can be disposed on the top surface 40. The reference electrode 14, a reference lead 46 and a conductive pad 8 can be disposed on the bottom surface 42. The end of the balanced sensor 200 that comprises the sensing electrode 10 can be referred to as the sensing end 34, and the end of the balanced sensor 200 that comprises the conductive pads 8 can be referred to as the connecting end 36.

The side of the electrolyte layer 12 that comprises the sensing electrode 10 can be referred to as the sensing side of the sensor, and the side of the electrolyte layer 12 that comprises the reference electrode 14 can be referred to as the reference side of the sensor.

Disposed on the sensing side can be sensing side layer(s) 22, which comprise a window support layer 50 and three outer window layers 56. The window support layer 50 can be layered onto the top surface 40 and comprise a sensor window 52, in which a protective insert 54 can be configured to nest. Also disposed on the window support layer 50 can be conductive pads 8 capable of providing electrical communication through the window support layer 50 and electrical communication with conductive pads 8 on adjacent layers and with sensor lead 44 and reference lead 46.

Layered onto the window support layer 50 can be three outer window layers 56. Disposed in the outer window layers 56 can be conductive pads 8 capable of providing electrical communication between the sensor contacts 6 disposed on the outer most outer window layer 56 to the conductive pads 8 disposed on the window support layer 50. Also disposed on the outer window layers 56 can be outer sensor windows 64 that can be disposed to provide fluid communication between the adjacent sensing windows (sensor window 52, outer sensor window 64) and the sensing electrode 10, through protective insert 54. The outer sensor windows 64 can form a “well” in which a protective coating 58 can be disposed. The well depth can also be varied by employing one or more truncated outer window layers 56 (or other truncated support layers) that does not comprise an outer sensor window. For example, it may be determined that a “well” depth equal to about three support layers deep produces a protective coating 58 thickness that hinders the passage of an exhaust gas through the protective coating 58. Therefore, the outermost outer window layer 56 can be truncated to produce a sensor comprising two outer sensor windows 64 (disposed in the outer window layers 56 between the truncated layer and the window support layer 50), which can provide acceptable gas diffusion and potentially reduce the sensors cost as the truncated layer does not require the processing required to form its' outer sensor window 64.

Disposed on the reference side can be reference side layer(s) 24, which can comprise a channeled support layer 60, two insulating layers 18, and a heater support layer 30. More specifically, layered onto bottom surface 42 can be a channeled support layer 60 that is capable of providing fluid communication of a reference gas to the reference electrode 14 through channel 62. Layered onto the channeled support layer 60 can be two insulating layers 18, on which a heater support layer 30 can be disposed. Disposed between an insulating layer 18 and the heater support layer 30 can be heating element 26 and leads 28, which are connected in electrical communication. Disposed on the outer surface of the heater support layer 30 can be heater contacts 32, which are connected in electrical communication with leads 28.

“Vias” or “via holes” comprising a conductive material can be employed to provide electrical communication through the layer and leads, contacts, additional vias or via holes, and the like, to enable sensor operation. Also, conductive pads 8 can be connected utilizing vias or via holes. Furthermore, designs employing vias or via holes can be configured without conductive pads 8.

During use, sensing electrode 10 can be disposed in fluid communication with a first gas (e.g., an exhaust stream) through the protective insert 54 and the protective coating 58, and connected in electrical communication with sensor contacts 6 through sensor lead 44 and conductive pads 8. Likewise, reference electrode 14 can be disposed in fluid communication with a second gas (e.g., atmospheric air) through channel 62 and connected in electrical communication with sensor contacts 6 through reference lead 46 and conductive pads 8. Contact with the differing gasses can generate an electromotive force across the electrolyte layer which can be measured utilizing the sensing electrode 10 and the reference electrode 14.

Although not limited by theory, the design of the balanced sensor 200 is generally more balanced than the basic sensor 100 (illustrated in FIG. 1) for the reason that the number of support layers that comprise the support side support layer 22 is equal to the number to the support layers that comprise the reference side layer(s) 24 (four support layers are disposed onto the sensing side and four support layers are layered onto the reference side of the sensor). This approximately balanced design can reduce or eliminate warpage of the sensor during sintering. Therefore, it is desirable to achieve an approximate balance between the sensing side layer(s) 22 and the reference side layer(s) 24. To be more specific, it is desirable that the thickness of the sensing side layer(s) 22 is not thicker than the reference side layer(s) 24 by more than 60% and the reference side layer(s) 24 is not thicker than the sensing side layer(s) 22 by more than 60%, more specifically, it is desirable that the thickness of the sensing side layer(s) 22 is not thicker than the reference side layer(s) 24 by more than 40% and the reference side layer(s) 24 is not thicker than the sensing side layer(s) 22 by more than 40%, even more specifically, it is desirable that the thickness of the sensing side layer(s) 22 is not thicker than the reference side layer(s) 24 by more than 20% and the reference side layer(s) 24 is not thicker than the sensing side layer(s) 22 by more than 20%. In other words, the reference side 24 has a total thickness (reference thickness) of about 40% to about 160% of a total thickness of the sensing side 22 (i.e., a sensing thickness), or, more specifically, the reference thickness is about 60% to about 140% of the sensing thickness, or, even more specifically, the reference thickness is about 80% to about 120% of the sensing thickness, and yet more specifically, the reference thickness is about 90% to about 110% of the sensing thickness. For example, if the sensing thickness is 10 units, the reference thickness will be 4 units to 16 units, or, more specifically, 6 units to 14 units, and even more specifically, 8 units to 12 units, and yet more specifically, 9 units to 11 units.

It is to be apparent the number of support layers and thicknesses of the support layers can be configured in any manner.

As well as being a more balanced design, by employing a sensor window 52 into the design of the balanced sensor 200 the protective insert 54 is generally smaller in size than the porous protective layer 2 of the basic sensor 100. This results in a decreased tendency for the balanced sensors 200 sensing end 34 to warp during sintering, as well as a cost savings from utilizing less protective insert 54 materials. Furthermore, the outer sensor windows 64 employed in the sensors design also provides several benefits. Firstly, the size and/or shape of the outer sensor window 64 can be configured to restrict the movement of the protective insert 54, by sizing the outer sensor window 64 smaller than the protective insert 54. For example, the protective insert can comprise a 4.0 millimeter (mm) by 4.0 mm square geometry and the outer sensor window 64 can comprise a 3.5 mm by 3.5 mm square geometry. This is beneficial as it provides assurance that the protective insert cannot be inadvertently displaced during manufacturing and encourages a proper seal to be formed around the upper surface of the protective insert 54 and the protective coating 58 so that exhaust gases cannot leak around the protective insert 54. In addition, by employing an outer sensor window 64 into the design a smaller quantity of quantity of protective coating 58 is utilized, resulting in an additional cost savings. Also, the outer sensor windows 64 form a “well” in which the protective coating 58 can be dispensed, which reduces the complexity of the coating process compared to other methods of coating (e.g. dip-coating), yet even further decreasing manufacturing costs. Furthermore, if an assembly process locates the tip of the sensor, if the protective coating 58 is only disposed within the well, the protective coating 58 will be less likely to fracture and detach from the sensor when it is located.

The materials that can be employed for the sensors can comprise the following. The electrolyte layer 12 can comprise metal oxides such as zirconia can be employed, which can be optionally stabilized with calcium, barium, yttrium, magnesium, aluminum, lanthanum, cesium, gadolinium, and the like, oxides thereof, as well as combinations comprising at least one of the foregoing materials. However, any materials that provide ionic communication between sensing electrode 10 and reference electrode 14 and can withstand the operating environment of the sensors (e.g., from about 500° Celsius to about 1,000° Celsius) can be employed. For example, the electrolyte layer 12 can comprise zirconia stabilized with about 3 molar percent yttria. The thickness of the electrolyte layer can be about 25 micrometers to about 500 micrometers, more specifically, about 100 micrometers to about 400 micrometers, even more specifically, about 200 micrometers to about 300 micrometers.

Although the electrolytic layer 12 is illustrated as a generally rectangular layer, any shape that can function in a sensor cell 38 can be employed (e.g. cylindrical, polygonal, and irregularly shaped). Furthermore, the electrolytic layer 12 can be produced by any method, such as, casting, pressing, roll compaction, stamping, punching, and other methods, as well as combinations comprising one or more of the foregoing.

Sensing electrode 10 and reference electrode 14 (hereinafter referred to as “electrodes”) can comprise any material(s) capable of generating an electrical current when contacting a gas to be sensed and withstanding the operating environment in which the sensors will be subjected (e.g., from about 500° Celsius to about 1,000° Celsius). Materials such as, but not limited to, metals (e.g. silver, copper, and the like), metal alloys, metal oxides, and combinations comprising at least one of the foregoing.

The electrodes can also comprise a catalyst capable of ionizing the gas to be sensed, including, but not limited to, metals such as platinum, palladium, osmium, rhodium, iridium, ruthenium, zirconium, yttrium, cerium, calcium, aluminum, silicon, and the like, and oxides, mixtures, and alloys comprising at least one of the foregoing catalysts. The catalyst is employed to both catalyze the oxidation reactions and to equilibrate the local oxygen concentrations.

Furthermore, the electrodes can be porous, wherein the electrodes total volume can comprise up to about 20 volume percent porosity comprising a median pore size of up to about 0.5 micrometers, which allows for transfusion of the gases.

Although illustrated with a square geometry, the electrodes can be of any shape that can function in a sensor cell 38 can be employed (e.g. round, oval, irregular). The size of the electrodes should be adequate to provide sufficient current output to enable reasonable signal resolution over a wide range of air/fuel ratios while preventing leakage between sensing electrode 10 and reference electrode 14. Signal amplification and conversion (e.g., analog to digital) conditioning methods can also be employed.

Generally, the electrodes comprise a thickness of about 1.0 micrometer to about 25 micrometers, more specifically, about 5 micrometer to about 20 micrometer, even more specifically, about 10 micrometer to about 15 micrometer. The electrodes can be formed by any method, such as, but not limited to, coating (e.g. dip coating, slurry coating), painting, printing (e.g. ink jet printing, pad printing, screen printing, stenciling, transfer printing), deposition (e.g. electro-static, flame, plasma, chemical vapor, electron beam, sputtering), and other methods, as well as combinations comprising at least one of the foregoing. Screen-printing for example provides simplicity, economy, and compatibility with the subsequent co-fired process. An example can be, screen-printing reference electrode 14 onto electrolyte layer 12 or onto the channeled support layer 60, the electrolyte layer 12 can then be layered onto the channeled support layer 60, and the laminate can be co-fired.

Leads 28, sensor lead 44, reference lead 46, sensor contacts 6, heater contacts 32, and conductive pads 8 (collectively referred to hereinafter as the “conductors”) can comprise any materials capable of conducting the electrical current generated across the electrolyte layer 12 and withstanding the operating environment in which the sensors will be subjected (e.g., about 500° Celsius to about 1,000° Celsius). Materials comprising any electrically conductive material can be employed, such as, but not limited to, metals (e.g. platinum, ruthenium, iridium, palladium, silver, copper, gold, and the like), metal alloys, metal oxides, and combinations comprising at least one of the foregoing.

The shape of the conductors can be configured in any manner to provide electrical communication as discussed, and it is to be apparent that the number, configuration, and orientation of the conductors is exemplary and non-limiting. Generally, the electrodes comprise a thickness of about 1.0 micrometer to about 25 micrometers. More specifically, a thickness of about 5 micrometers to about 20 micrometers can be deposited. Yet even more specifically, a thickness of about 10 micrometers to about 15 micrometers can be deposited. The electrodes can be formed by any method, such as, but not limited to, coating (e.g. dip coating, slurry coating), painting, printing (e.g. ink jet printing, pad printing, screen printing, stenciling, transfer printing), deposition (e.g. electro-static, flame, plasma, chemical vapor, electron beam, sputtering), and other methods, as well as combinations comprising one or more of the foregoing. Screen-printing for example provides simplicity, economy, and compatibility with the subsequent co-fired process. Furthermore, electrical communication can be provided through the layers and/or between conductors by forming holes in the layers prior to forming the conductors. These holes can subsequently be filled with electrically conductive materials to provide electrical communication thereafter.

The support layers (i.e. insulating layer 18, window support layer 50, outer window layer 56, heater support layer 30, channeled support layer 60) provide physical durability, strength, and electrical insulation to various components of the sensor. The materials employed for the support layers can comprise any materials capable of providing these functions and withstanding the operating environment in which the sensors will be subjected (e.g., about 500° Celsius to about 1,000° Celsius). More specifically, metal stabilized oxides (e.g. spinel, alumina, magnesium oxide), and the like, as well as combinations comprising at least one of the foregoing can be employed. It is desirable however that the materials employed for the support layers and the electrolyte layer 12 exhibit similar coefficients of thermal expansion, shrinkage, and chemical compatibility in order to minimize or eliminate, warpage, delamination and other processing problems.

The support layers can be produced by any method, such as, casting, pressing, roll compaction, stamping, punching, and other methods, as well as combinations comprising one or more of the foregoing. The thickness of the supporting layers can be about 25 micrometers to about 500 micrometers, or more specifically about 100 micrometers to about 400 micrometers, and even more specifically, about 200 micrometers to about 300 micrometers. Also, it is to be apparent that the number, configuration, and orientation of the support layers are exemplary and non-limiting.

Heating element 26 can be any element capable of heating the sensor to a temperature that is conducive for sensor operation. The heating element 26 can comprise any design, orientation, or configuration, however it is desirable that a design is employed that can provide an even temperature distribution across the sensing end 34. Materials that can be employed for the heating element 38 can comprise, metals (e.g. platinum, palladium), metallic alloys, metallic mixtures, resistive materials (e.g. carbon, tungsten), the like, as well as combinations comprising at least one of the foregoing. Heating element 26 can be produced by any method, such as, but not limited to, coating (e.g. dip coating, slurry coating), painting, printing (e.g. ink jet printing, pad printing, screen printing, stenciling, transfer printing), deposition (e.g. electro-static, flame, plasma, chemical vapor, electron beam, sputtering), and other methods, as well as combinations comprising one or more of the foregoing. Screen-printing methods however provide simplicity, economy, and compatibility with the subsequent co-fired process.

Although not shown, a ground plane can be disposed between the heating element 26 and the sensor cell 3, or in any other location within the sensor, to inhibit, for example, sodium-induced heater failure. Sodium induced heater failure can occur due to sodium ion accumulation on the heaters surface. More specifically, sodium ions can be produced from contaminants within the support layers at elevated temperatures. The ground plane inhibits the accumulation of the ions on the heater by attracting the ions by emitting a negative potential.

Channel 62 is a conduit that allows fluid communication between a reference gas (e.g. atmospheric air) and the reference electrode 14. The channel 62 can be formed into the channeled support layer 60 during its production utilizing any method, such as, but not limited to, casting, pressing, roll compaction, stamping, punching, and other methods, or formed into the channel 62 in a subsequent operation, such as, but not limited to, grinding, milling, or the like, as well as combinations comprising one or more of the foregoing. The dimension of the channel 62 can comprise any dimensions sufficient for its function, it is to be understood that the dimensions can the tailored for the specific sensor design. It is envisioned that in additional embodiments a gas channel 16 or space can be formed by depositing a fugitive material (e.g. carbon black) between reference electrode 14 and the channeled support layer 60, which can burn off during the sintering process to leave a conduit capable of connecting the reference electrode in fluid communication with the reference gas.

A protective insert 54 can be disposed within the sensor window 52 between the protective coating 58 and the sensing electrode 10. The protective insert 54 (as well as the porous protective layer 2) can comprise any material that enables fluid communication between the sensing electrode 10 and a test gas, such as a porous ceramic material formed from a precursor comprising a ceramic (such as a spinel, alumina, zirconia, and/or the like), a fugitive material (e.g., carbon black), and/or an organic binder, as well as combinations comprising at least one of the foregoing. For example, the precursor can comprise about 70 to about 80 wt. % ceramic material(s), about 5 to about 10 wt. % fugitive material(s), and about 15 wt. % to about 20 wt. % of an organic binder. The protective insert 54 can be pre-formed, cut and inserted into the sensor window. In addition, the precursor can be disposed in the sensor window 52 utilizing additional methods, such as, but not limited to, coating, painting, printing (e.g. ink jet printing, pad printing, screen printing, stenciling, transfer printing), as well as combinations comprising one or more of the foregoing. After the protective insert 54 (or precursor) has been inserted into the sensor window 52, the assembly can be sintered. The resulting protective insert 54 can comprise a total volume less than or equal to about 20 volume percent porosity. The resulting median pore size can be less than or equal to about 0.5 micrometers in diameter.

The protective coating 58 can comprise one or more metallic oxide(s) and inorganic binder(s). In addition, one or more fugitive material(s) can be employed to provide porosity. In one embodiment, a slurry can be produced by mixing the metallic oxides (e.g., low-soda alpha alumina, stabilized gamma alumina) with one or more inorganic binders (e.g., aluminum nitrate, zirconium acetate), and a fugitive materials (e.g., carbon black). The slurry can be disposed within the outer sensor window 64 and sintered.

Protective coating 58 can facilitate the formation of particulates that readily precipitate out of the exhaust gas. As the particulates are encouraged to precipitate, fewer impervious glass materials are formed on the sensor as a result of the interaction of alkaline earth metals and acid gases in the exhaust stream. Therefore, the sensor demonstrates improved resistance to poisoning by acid gases within the exhaust stream due to the ability of protective coating 58 to form a protective barrier over the protective insert 54. The protective coating 58 can be porous and comprise less than or equal to about 20 volume percent porosity. Furthermore, the coating's median pore size can be equal to or less than about 0.5 micrometers. Exemplary coatings can comprise a precursor of gamma alumina and a fugitive material (e.g., carbon black).

As discussed herein, planar gas sensors can be susceptible to warping during the sintering operation. Although planar designs provide advantages, such as, reduced sintering operations, excellent layer adhesion, and reduced overall part cost, the detrimental effects of warpage counteracts these benefits due to costly production scrap-rates, high raw materials costs, and high quality assurance costs. As a result, it is desirable to develop methods of reducing or eliminating sensor warpage.

The sensor disclosed herein exhibits a reduced susceptibility to warping during sintering. This is accomplished by improving the laminar balance of a gas sensor by rearranging, adding, and/or removing support layers, disposing the electrolyte layer closer to the center (or mid-plane) of the part, and by reducing the size of the porous protective material located at the sensing end 34 of the sensor. To be able to add sensor layers onto the top surface 40 of the device, sensing windows were created in the support layers in order to maintain fluid communication of the sensing electrode 10 with the test gas.

The innovation of the sensing windows is desirable to manufactures and consumers because in addition to reducing warpage of the sensor during manufacturing, manufacturing costs can be reduced, a difficult manufacturing step can be eliminated, a method of controlling the thickness of the protective coating 58 can be employed, a method of “locking” a protective insert 54 into the tip of the sensor, and the durability of the device may be increased.

First, manufacturing costs associated with increased quality assurance, production scrap costs, and the handling and packaging difficulties associated with warped sensors are reduced as a result of decreasing or eliminating the tendency and susceptibility of warpage. Second, by integrating the sensing windows (sensor window 52, outer sensor window 64) the size of the protective insert 54 and the amount of protective coating 58 has been reduced (compared to the porous protective layer 2 of the basic sensor 100). Third, coating gas sensors can present several challenges (e.g. handling, automation, fixturing). Through the integration of the sensing windows, a “well” has been formed in which the protective coating 58 can be dispensed. This enables the replacement of challenging coating processes with less challenging processes and reduces the cost of the coating process as the amount of coating can be reduced. Fourth, manufacturers are now offered a method of controlling the thickness of the protective coating 58 by varying the number of support layers comprising sensing windows to vary the depth of the “well” in which the protective coating 58 can be dispensed. Fifth, integrating the sensing windows into the design of the gas sensors disclosed herein allows a method for restraining the protective insert 54 within the sensing end 34 of the sensor. This can provide for greater durability and ensure proper sealing with the protective coating 58. Finally, the overall durability and strength of the sensor can be increased with the addition of supporting layers. Also, with the integration of the sensing windows, the sensing end 34 is provided additional protection around the sensing electrode 10. As a result of these benefits, the gas sensor designs disclosed herein are desirable by both manufacturer and consumer alike for the reasons they decrease overall part cost and increase the durability of the device.

Although the present disclosure presents gas sensors and embodiments thereof in connection with oxygen sensors, it is to be understood that the devices, methods, improvements, and suggestions disclosed herein can be employed with any type of sensor (e.g., oxygen, hydrogen, hydrocarbon, nitrogen oxides, and the like). Also, although the disclosure describes planar sensor designs, it is to be understood the devices, methods, improvements, and suggestions herein can be employed with any geometry or type of sensor, such as, but not limited to, wide range sensors, and the like. Furthermore, it is to be apparent that additional elements (e.g. sensing window(s), lead gettering layer(s), ground plane(s), support layer(s), truncated outer window layer(s), electrochemical cell(s), and the like) can be incorporated into the devices disclosed herein without departing from the scope of the invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A gas sensor, comprising:
a sensor cell comprising an electrolyte layer, a sensing electrode and a reference electrode, wherein the sensing electrode is disposed on a sensing side of the electrolyte layer, and the reference electrode is disposed on a reference side of the electrolyte layer;
a sensing side support layer disposed on the sensing side; and
a reference side support layer disposed on the reference side;
wherein the reference side has a reference thickness of about 40% to about 160% of a sensing thickness of the sensing side.

2. The gas sensor of claim 1, wherein the reference thickness is about 60% to about 140% of the sensing thickness.

3. The gas sensor of claim 2, wherein the reference thickness is about 80% to about 120% of the sensing thickness.

4. The gas sensor of claim 1, wherein the sensing side further comprises a truncated support layer.

5. The gas sensor of claim 1, wherein the sensing side support layer further comprises a sensor window disposed in fluid communication with the sensing electrode.

6. The gas sensor of claim 5, further comprising a protective insert disposed within the sensor window.

7. The gas sensor of claim 5, wherein the sensing side support layer further comprises an outer sensor window disposed in fluid communication with the sensor window.

8. The gas sensor of claim 7, wherein the outer sensing window is capable of retaining a protective insert within the sensor window.

9. The gas sensor of claim 7, further comprising a protective coating disposed within the outer sensor window.

10. A method of making a gas sensor, comprising:
forming a sensor cell comprising an electrolyte layer, a sensing electrode and a reference electrode, wherein the sensing electrode is disposed on a sensing side of the electrolyte layer, and the reference electrode is disposed on a reference side of the electrolyte layer;
disposing a sensing side support layer on the sensing side; and
disposing a reference side support layer on the reference side;
wherein the reference side has a reference thickness of about 40% to about 160% of a sensing thickness of the sensing side.

11. The method of making the gas sensor of claim 10 further comprising:
disposing a sensor window in the sensing side support layer in fluid communication with the sensing electrode; and,
disposing a porous protective insert in the sensor window.
